(19) United States
(12) Patent Application Publication
(10) Pub. No.: US 2022/0345313 A1
(43) Pub. Date: Oct. 27, 2022

(54) SERVER NODE, DIGITAL ASSISTANT AND METHODS IN A COMMUNICATIONS NETWORK FOR HANDLING ACCESS CONTROL

(71) Applicant: Telefonaktiebolaget LM Ericsson (publ), Stockholm (SE)

(72) Inventor: Ester Gonzalez De Langarica, Vitoria (ES)

(21) Appl. No.: 17/765,032

(22) PCT Filed: Sep. 30, 2019
(86) PCT No.: PCT/SE2019/050941

§ 371 Date: Mar. 30, 2022

(51) Int. Cl. H04L 9/32; H04L 9/08; H04L 9/40; H04W 12/69

(52) U.S. Cl. CPC H04L 9/3231; H04L 9/0833; H04L 63/102; H04L 63/0263; H04W 12/69

(57) ABSTRACT

A method performed by a server node for handling access control of a request to access information from a first user is provided. Based on a group identity, the server node establishes that a first UE uses a DA that is shared. The server node decides whether the first user of the first UE is enforced to access control to get access to the requested information, based on the type of information requested, the voice profile identity and that the DA for providing the voice message is shared.

### TECHNICAL FIELD

Embodiments herein relate to a server node, a Digital Assistant (DA) and methods therein. In particular, they relate to handling access control of a request to access information from a first user.

### BACKGROUND

In a typical wireless communication network, wireless devices, also known as wireless communication devices, mobile stations, stations (STA) and/or user equipment (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

IMS is a general-purpose, open industry standard for voice and multimedia communications over packet-based IP networks. It is a core network technology, that may serve as a low-level foundation for technologies like Voice over LTE (VoLTE) Voice over IP (VoIP), Push-To-Talk (PTT), Push-To-View, Video Calling, and Video Sharing.

Over-The-Top (OTT) services have been introduced allowing a third party telecommunications service provider to provide services that are delivered across an Internet Protocol (IP) network. The IP network may e.g. be a public internet or cloud services delivered via a third party access network, as opposed to a carrier's own access network. OTT may refer to a variety of services including communications, such as e.g. voice and/or messaging, content, such as e.g. TV and/or music, and cloud-based offerings, such as e.g. computing and storage.

A further OTT service is a Digital Assistant (DA). The DA may perform tasks or services upon request from a user of a UE.

A core network node may detect a keyword, which may also be referred to as a hot word, indicating that the user is providing instructions to the DA and may forward the instructions to a network node controlled by a third party service provider, the network node may e.g. comprise a DA platform.

An intent is an abstract description of an operation to be performed. An Intent provides a facility for performing late runtime binding between the code in different applications. Its most significant use is in a launching of activities, where it may be thought of as the glue between activities. It is basically a passive data structure holding an abstract description of an action to be performed.

When a user calls startActivity( ) or startActivityForResult( ) and pass it as an implicit intent, the system resolves the intent to an application that can handle the intent and starts its corresponding Activity. If there is more than one application that can handle the intent, the system presents the user with a dialog to pick which application to use.

E.g. a user is saying to its DA: “DA, call Bob”. “DA” is in this case the keyword, or anything configured by the operator, and “Call Bob” is the “intent” The trigger to wake up the DA is the keyword. Then the intent can be call Bob or other actions available.

A DA platform may e.g. be a bot of a company providing a certain service, such as e.g. a taxi service or a food delivery service. An Internet bot, also known as a web robot, a WWW robot or simply a bot, is a software application that runs automated tasks such as scripts, over the Internet. Typically, bots perform tasks that are both simple and structurally repetitive, at a much higher rate than would be possible for a human alone.

The DA platform may then forward the instructions to a further network node, which may e.g. be an Application Server (AS) node, an agent server node, a skill server node or similar. This further network node has access to the core network node such as an IMS node via a Service Exposure Application Programming Interface (API). Thereby the DA may access the IMS node and perform services towards the core network node.

The DA platform is often required to pay a fee to the operator in order to be reachable by the operator's DA users. The user may also be required to pay fees to the operator and network provider for the usage of DA services. The operator may further be required to pay fees to the network provider for every transaction performed via the Service Exposure API.

A further way to implement the DA may be to provide the user with direct access to the network node controlled by the third party service provider comprising the DA platform. This may e.g. be done using a dedicated UE having access to the network node. This way of implementing the DA is commonly referred to as an OTT-controlled DA.

One of the services that can be invoked may e.g. be a telephony services or bot, implemented by the operator.

In OTT-controlled DA, a keyword detection is done by the OTT DA and the request is fulfilled in the OTT cloud. Sessions are initiated from the OTT DA towards the operator network. When the request relates to service interaction and/or service manipulation, the OTT DA must use IMS service exposure APIs to access IMS capabilities. An OTT DA may e.g. comprise an OTT DA device such as a smart speaker such as e.g. Amazon echo or Google Home speakers, and e.g. the OTT DA may comprise an application interacting with the IMS network, and an OTT platform. A Service Exposure API when used herein means an API exposing the IMS capabilities to third party applications. These capabilities are for example call handling, message handling, supplementary service handling etc.

Access to Voicemail, Text Messages and Call Log from a UE

In voicemail access, a user of a UE may access to his/her voicemail typically by calling to the voicemail and entering a Personal Identification Number (PIN) code via Dual-tone multi-frequency (DTMF). For Example: Regarding text messages and call log, a user of a UE may access the text messages by looking at the phone and the same apply if the user wants to check the call log. This kind of information is typically sensitive and private and it should only be accessible by the rightful owner.

Access to the Voicemail, Text Messages and Call Log Using a Digital Assistant

A user of a UE may access to his/her voicemail, text messages and call log using the Digital Assistant. Typical use cases, using a Digital Assistant called Alexa, may be:
Alexa, read my text messages, delete my text messages, read my last message, read my messages from yesterday, etc.
Alexa, check my voicemail, read my last voice message, read my last voice message from Bob, etc.
Alexa, check who called yesterday, remove the call log, etc.

Note that when Alexa or Amazon are mentioned it could be applied to any other Digital Assistant echo system, e.g. Google, Microsoft, operator DA, etc.

The figure below shows the voice message retrieval example. The Amazon Echo is not shared in the example.

FIG. 1 depicts an example of an OTT-controlled DA illustrating a voice message retrieval where a DA smart speaker is not shared with other users. In the example, a user Alice of a UE accesses the last voice message in the voicemail by using the Digital Assistant smart speaker.

Alice owns the UE and the OTT DA such as an Amazon echo. One of the services that may be invoked is the voicemail services or bot, implemented by the operator or by third parties via an operator.

In this example, the user Alice invokes the OTT DA, by saying “Alexa read my last voice message”, where “Alexa” is the keyword.

Keyword detection is done locally in the OTT DA. This voice keyword is streamed to an OTT Skill Platform. Service Exposure is needed in the IMS network to access IMS capabilities from the OTT. Therefore the OTT Skill Platform sends a Hypertext Transfer Protocol (HTTP)/Representational State Transfer (REST) “read my last voice message”, user Id=Alice” to the skill/agent server of the operator. The skill/agent server parses this request and matches the identity to the IMS user identity, e.g. private Id, or public Id, and sends e.g. an HTTP/REST “IMS Service Exposure API Retrieve last voice message for user Id=Alice to an IMS network node, which returns a Message comprising “I am late for dinner”, including a timestamp=XXX, and a sender Id=Bob.

HTTP/REST is a protocol supported between the skill server and the IMS core network. SIP/RTP in the Figures relate to the IMS protocol.

Shared Das Such as Smart Speakers, e.g. Google and Amazon

Google and Amazon are some of the Digital Assistant platform providers. One of the features they support is the ability to identify different person's voice coming from one shared smart speaker.

First the smart speaker's users “teach” their voice to the DA platform, i.e. the users create a voice profile. The typical case is when the DA is shared among the family members in the household.

Thanks to this feature the DA can provide a personalized experience to the users.

Voice Profiles

E.g. Amazon DAs support the creation of “voice profiles”. The experience may be personalized for Alexa features of the DA. Having an active voice profile gives a personalized experience for a user with a vice profile, e.g. for the following features:
Regarding Alexa Calling and Messaging, play messages are sent only to the user, and send messages only from the user.
Regarding Flash Briefing, When Alexa recognizes the voice of the user, Flash Briefing skips stories and news items the user already has heard.
Regarding Shopping, if the user has a voice code enabled, the user does not have to say the voice code every time the user completes a purchase.
Regarding Music, If the user has the Amazon Music Unlimited Family Plan, Alexa customizes music playback based on voice.

### SUMMARY

As a part of developing embodiments herein the inventors identified a problem which first will be discussed.

As mentioned above, the content of a received voice messages or text messages or the call log are private and sensitive information. When accessing from a UE like a smartphone, laptop or tablet, the information is protected with the device pin, fingerprint or facial recognition, and from the fact that it's usually a personal device, i.e. not shared.

A DA smart-speaker is usually a shared device, i.e. any member of the family will have access to it and will be able to issue this kind of requests.

A voice profile is a good approach but it is not 100% infallible and it may lead to violation of privacy. I.e. wrong voice profile assigned to the person, e.g. guests visiting etc. An additional access control would be needed.

Summarizing the problem is that there is no access control to protect the sensitive information such as voice or text messages etc. when invoked from a Digital Assistant application or smart speaker.

An object of embodiments herein is to improve the user experience in a communications network using DAs.

According to an aspect of embodiments herein, the object is achieved by a method performed by a server node for handling access control of a request to access information from a first user. The information is related to a first User Equipment, UE A1, of the first user. The information is requested to be provided as a voice message by a Digital Assistant, DA, used by the first user of the first UE A1. The DA is shared by the first user of the first UE A1 and a second user of a second UE A2. The server node receives from the DA, the request to access the information, a voice profile identity identifying a voice profile associated with the first user of the first UE A1, and a group identity identifying a group of users of UEs sharing the DA. The group of users comprises at least the first user of the first UE A1 and the second user of the second UE A2. Based on the group identity, the server node establishes that the first UE A1 uses the DA 125 that is shared. The server node decides whether the first user of the first UE A1 is enforced to access control to get access to the requested information, based on the type of information requested, the voice profile identity and that the DA for providing the voice message is shared.

According to another aspect of embodiments herein, the object is achieved by a method performed by a Digital Assistant, DA, for handling access control of a request to access information from a first user.

The DA receives a voice message from the first user. The voice message comprises the request to access information. The information is related to a first User Equipment, UE, A1 of the first user. The information is requested to be provided as a voice message by the DA used by the first user of the first UE A1. The DA is shared by the first user of the first UE A1 and a second user of a second UE A2. The DA sends to a server node, the request to access the information, a voice profile identity identifying a voice profile associated with the first user of the first UE A1, and a group identity identifying a group of users of UEs sharing the DA. The group of users comprises at least the first user of the first UE A1 and the second user of the second UE A2. When decided that the first user of the first UE A1 is enforced to access control to get access to the requested information based on the type of information requested, the sent voice profile identity and group identity, the DA receives an instruction from the server node, to request a personal shared secret from the first user, for access control.

According to a further aspect of embodiments herein, the object is achieved by a server node configured to handle access control of a request to access information from a first user. The information is adapted to be related to a first User Equipment, UE, A1 of the first user. The information is requested to be provided as a voice message by a Digital Assistant, DA, used by the first user of the first UE A1. The DA is to be shared by the first user of the first UE A1 and a second user of a second UE A2. The server node is further configured to:
Receive from the DA, the request to access the information, a voice profile identity identifying a voice profile associated with the first user of the first UE A1, and a group identity identifying a group of users of UEs sharing the DA, which group of users is adapted to comprise at least the first user of the first UE A1 and the second user of the second UE A2,
based on the group identity, establish that the first user of the first UE A1 uses the DA that is shared, and
decide whether the first user of the first UE A1 is enforced to access control to get access to the requested information, based on the type of information requested, the voice profile identity and that the DA 125 for providing the voice message is shared.

According to a further aspect of embodiments herein, the object is achieved by a Digital Assistant, DA, configured to handle access control of a request to access information from a first user. The DA is further configured to:
Receive from the first user, a voice message comprising the request to access information, which information is adapted to be related to a first User Equipment, UE, A1 of the first user, and which information is requested to be provided as a voice message by the DA used by the first user of the first UE A1, and which DA is adapted to be shared by the first user of the first UE A1 and a second user of a second UE A2,
send to a server node, the request to access the information, a voice profile identity identifying a voice profile associated with the first user of the first UE A1, and a group identity identifying a group of users of UEs sharing the DA, which group of users is adapted to comprise at least the first user of the first UE A1 and the second user of the second UE A2, and
when decided that the first user of the first UE A1 is enforced to access control to get access to the requested information based on the type of information requested, the sent voice profile identity and group identity, receive an instruction from the server node, to request a personal shared secret from the first user.

In this way access control is provided to protect sensitive information such as voice messages when invoked from a Digital Assistant. This will results in an improved user experience in a communications network using DAs.

### BRIEF DESCRIPTION OF THE DRAWINGS

Examples of embodiments herein are described in more detail with reference to attached drawings in which:

FIG. 1 is a schematic block diagram illustrating prior art.

FIG. 2 a and b are a schematic block diagrams illustrating embodiments of a communications network.

FIG. 3 is a sequence diagram depicting embodiments of a method in a communications network.

FIG. 4 is a sequence diagram depicting embodiments of a method in a communications network.

FIG. 5 is a flowchart depicting embodiments of a method in a server node.

FIG. 6 is a flowchart depicting embodiments of a method in a DA.

FIGS. 7 a and b are schematic block diagrams illustrating embodiments of a server node.

FIGS. 8 a and b are schematic block diagrams illustrating embodiments of a DA.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11 to 14 are flowcharts illustrating methods implemented in a communication system including a host computer, a base station and a user equipment.

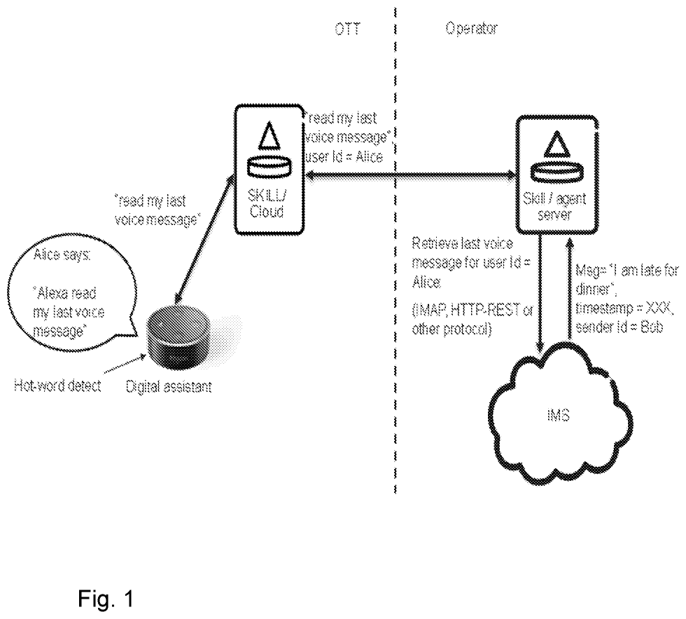

### DETAILED DESCRIPTION

Example embodiments herein provide Sensitive information access control in Digital Assistant scenarios.

Embodiments herein may relate to OTT-controlled DA model.

Embodiments herein provide an access control mechanism to prevent sensitive voice messaging information to be disclosed to the wrong user when using a DA that is shared between other users.

An example of an advantage of embodiments herein relate to that some operators are launching services that include access to voicemail, text messages and call log information, and in general, sensitive information via a DA. Embodiments herein provide an extra authentication mechanism when DA is a shared device, to protect the user's privacy.

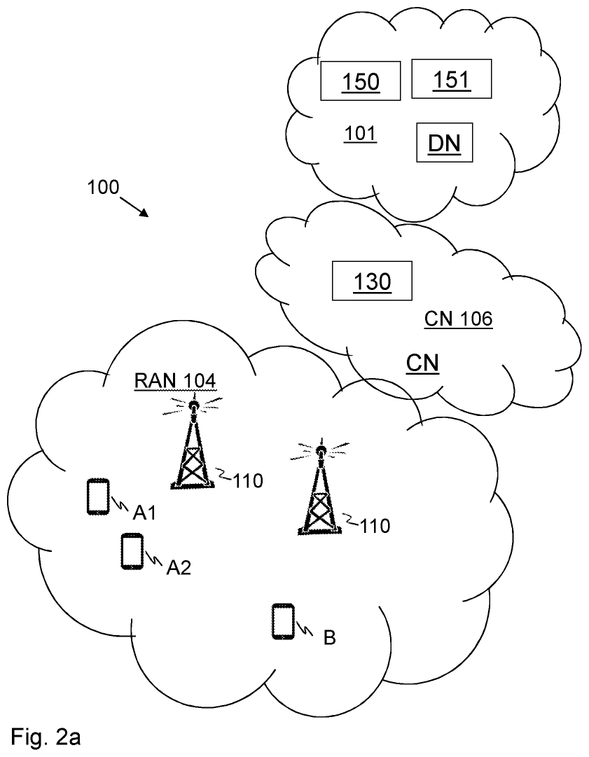

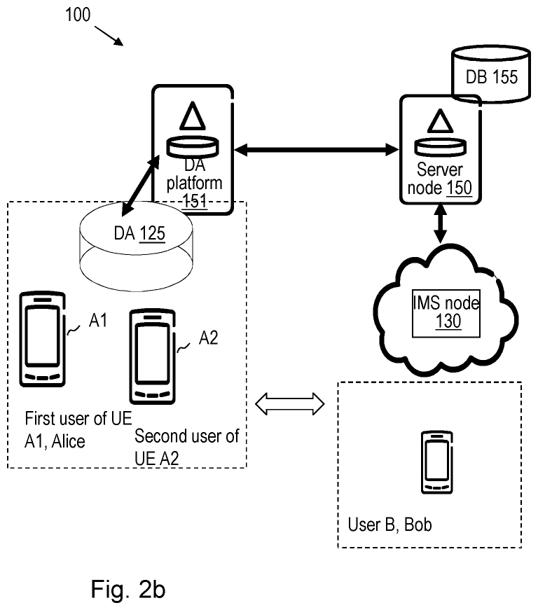

FIG. 2a is a schematic overview depicting a communications network 100 wherein embodiments herein may be implemented. FIG. 2b is depicting an example scenario of some nodes being a part of the communications network 100 wherein embodiments herein may be implemented. The communications network 100 may be a wireless communications network and comprises one or more RANs 104 and one or more CNs 106. The wireless communications network 100 may use 5G NR but may further use a number of other different technologies, such as, W-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Network nodes operate in the wireless communications network 100, such as one or more radio network nodes 110 providing radio coverage to UEs in the wireless communications network 100.

Each radio network node 110 provides radio coverage over a geographical area by means of antenna beams. The geographical area may be referred to as a cell, a service area, beam or a group of beams. The radio network node 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within the cell served by the radio network node 110 depending e.g. on the radio access technology and terminology used.

UEs such as a first UE A1, a second UE A2 and a third UE B operate in the communication network 100.

The UEs A1, A2 and B may e.g. each be any of a mobile station, a non-access point (non-AP) STA, a STA, a user equipment and/or a wireless terminals, an NB-IoT device, an eMTC device and a CAT-M device, a WiFi device, an LTE device and an NR device communicate via one or more Access Networks (AN), e.g. RAN, to one or more core networks (CN). It should be understood by the skilled in the art that “UE” is a non-limiting term which means any terminal, wireless communication terminal, wireless device, Device to Device (D2D) terminal, or node e.g. smart phone, laptop, mobile phone, sensor, relay, mobile tablets, television units or even a small base station communicating within a cell.

The first UE A1 is used by a first user, the second UE A2 is used by a second user and the calling UE B is used by a third user.

A DA 125 operates in the communications network 100. According to example embodiments herein at least the first user uses the DA 125 which is shared with the second user. This means that DA 125 is shared at least between the first user of the first UE A1 and the second user of the second UE A2. The DA 125 may also be shared with other users of other UEs. E.g. the first user may be Alice and the second user may be Alice's daughter. The DA 125 may comprise a DA apparatus such as e.g. a smart speaker, e.g. located in the first and second user's home.

The DA 125 may e.g. be a DA comprising or being accessible to a DA platform also referred to as a DA platform 151, e.g. in a cloud 101.

When used herein, the DA 125 and the DA platform 151 may be seen as one unit, i.e. that the OTT DA 125 is associated with or comprises the DA platform 151. The DA 125 may comprise a client which may be an entity that sends requests towards a server node 150 described below.

The CN 106 further comprises a core network node such as an IMS node 130 comprised in an IMS network. The IMS node 130 is e.g. used for serving requests coming via a Service Exposure API.

The IMS node 130 may be connected to a server node 150. The server node 150 may be located in the cloud 101 as depicted in FIG. 2a, in the CN 106 or in a third Party domain of the communications network. The server node 150 may be a server such as a skill server or an agent server. The server node 150 may have access to a Database (DB) 155 as depicted in FIG. 2b.

Furthermore, the DA 125 and the server node 150 may be collocated nodes, stand-alone nodes or distributed nodes comprised in the cloud 101.

An example of embodiments herein comprises: The server node 150 receives a voice profile identity. A set of rules are pre-defined by the first user that may be registered in the server node 150. The set of rules are enforced based on the voice profile id sent by the DA 125 such as its OTT cloud.

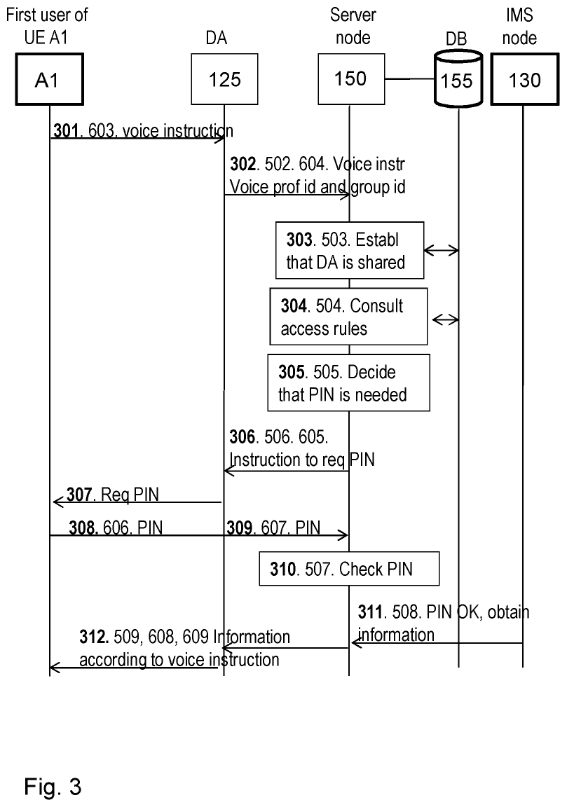

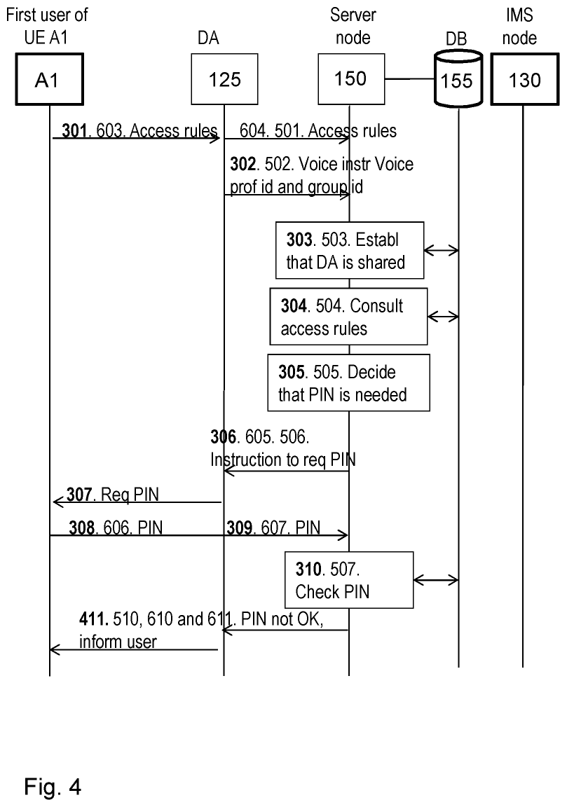

The method will first be described from a helicopter perspective as a signalling diagram showing the involved nodes such as the server node 150 and the DA 125, and IMS node 130 with reference to FIG. 3 and FIG. 4. A personal shared secret which in these examples represented by a PIN is used for access control.

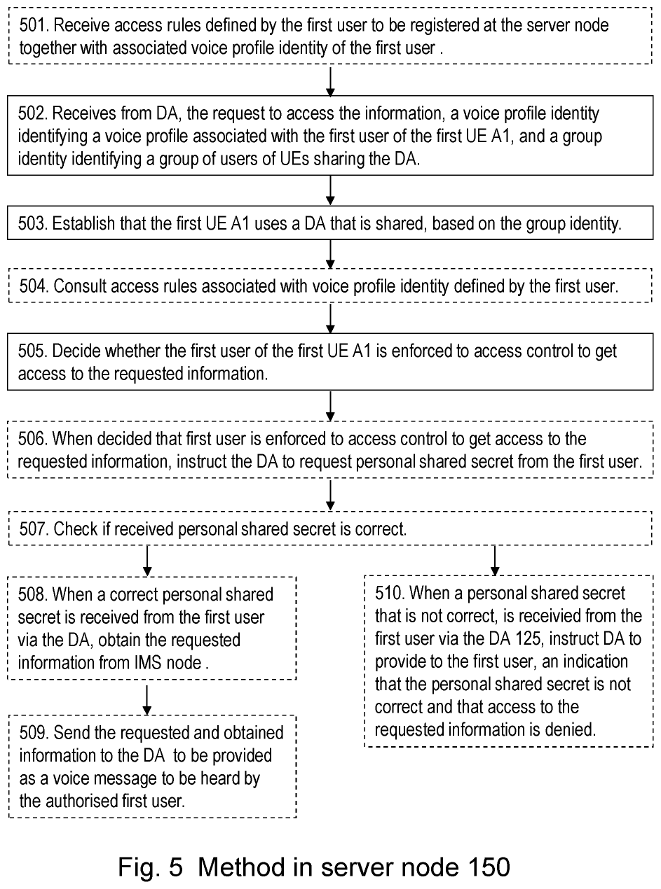

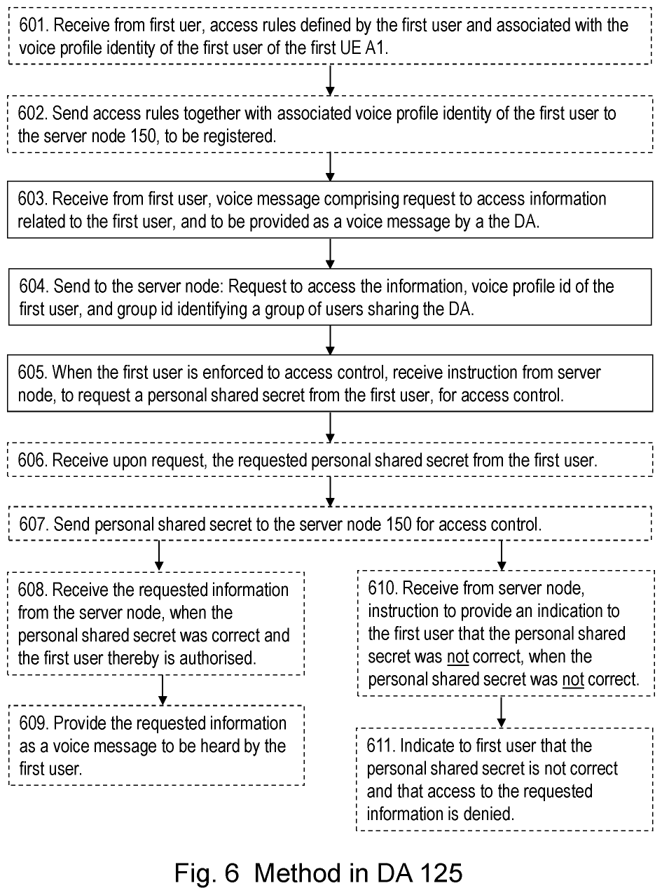

FIG. 3 shows an example scenario where the PIN is correct, and FIG. 4 shows an example scenario where the PIN is not correct. Thereafter embodiments of the method as seen from the perspective of each respective server node 150 and DA 125 will be individually described one by one with reference to respective flow charts of FIGS. 5 and 6.

In an example scenario of embodiments herein the first user Alice of a UE A1 is a DA 125 user. She shares the DA 125 with a second user e.g. her daughter, of the second UE A2. Alice wished to have privacy for her voice mails. Therefore the first user Alice will enforce the DA 125 to perform access control, when some user askes the DA 125 to announce a voicemail belonging to Alice in the DA 125. This may be done in a voice profile associated with the first user Alice of the first UE A1 that Alice has registered in the server node 150

An example embodiment of a method performed in the communications network 100 for handling access control of a voice message to the first UE A1 owned by Alice, will now be described with reference to a sequence diagram depicted in FIG. 3.

Action 301.

In the example scenario Alice detects that a user Bob of the third UE B has sent a voice message to Alice's UE A1. Alice is curious of the voice message and says to the DA 125: “DA (the Hot word), read my last voice message”

This action relates to Action 603 described below.

Action 302.

The hot-word is detected by the DA 125. The voice “read my last voice message” may e.g. be streamed from DA device to DA platform within the DA 125. The DA 125 e.g. its DA platform identifies the voice profile identity (id) and a group id of Alice. The DA 125 e.g. its DA platform, sends group id=family id, voice profile id=mother, and the message “read my last voice message” to server node 150.

This action relates to Action 502 and 604 described below.

Action 303.

Based on the group identity, the server node 150 establishes that the user Alice uses the DA 125 that is shared in a group of users. This may be performed by checking the group identity in the database 155.

This action relates to Action 503 described below.

Action 304.

The server node 150 consults, such as checks e.g. in the database 155 accessible by the server node 150, the access rules defined by the first user Alice. The access rules are associated with the voice profile identity of Alice received from the DA 125. The access rules defined by the owner Alice of UE A1 is associated to the voice profile id. The rules may be enforced based on the voice profile id e.g. sent by an OTT cloud related to the DA 125.

This action relates to Action 504 described below.

Action 305.

The server node 150 finds that a PIN is needed for access control. This may be checked in the Access rules saved in the DB 155 and accessible by the server node 150.

This action relates to Action 505 described below.

Action 306.

The server node 150 instructs the DA 125 to request (req) a PIN e.g. by sending a message “Hi Alice, I need to get your PIN. Say it out loud if you are alone or type it from the phone to the following number XYZXYZ” from the server node 150 to the DA 125 such as its DA platform 151. This action relates to Action 506 and 605 described below.

Action 307.

The message “Hi Alice, I need to get your PIN. Say it out loud if you are alone or type it from the phone to the following number XYZXYZ” is sent as Voice that is streamed from the DA 125 such as its DA platform 151.

This action relates to Action 606 described below.

Action 308.

The first user Alice hears the message from the DA 125. and enters her PIN “0 1 2 3” e.g. by saying it or by enter it to her UE, the first UE A1 to be obtained by the DA 125. E.g. the voice message “0 1 2 3” is streamed from the DA 125 to its DA platform 151.

This action relates to Action 606 described below.

Action 309.

The DA 125 e.g. its DA platform 151 forwards the PIN “0 1 2 3” of the first user Alice to the server node 150. This action relates to Action 607 described below.

Action 310.

The server node 150 checks if the PIN is correct. If so Access will be granted. This action relates to Action 507 described below. This is checked in an Authentication information related to the voice profile id of the first user Alice, e.g. in a data base 155 accessible by the server node 150.

Until here all actions are the same for FIG. 3 and FIG. 4. In the following the actions performed when the PIN is correct is illustrated in Actions 311 to Action 312 in FIG. 3, and the actions performed when the PIN is not correct is illustrated in Action 411 in FIG. 4.

Correct Personal Shared Secret Such as PIN, See FIG. 3

Action 311.

When checked that the PIN is correct, the server node 150 sends a request and a receiver id of the UE A1 to the IMS node 130 to retrieve the voice message e.g. by using IMAP, HTTP-REST or other protocol. The IMS node 130 retrieves the voice message from the user Bob of the third UE B “I am late for dinner”, a timestamp, and a sender Id of UE B, and sends it back to the server node 150. This action relates to Action 508 described below.

Action 312.

The server node 150 sends the voice message “I am late for dinner”, a timestamp, and a sender Id of the user Bob of the third UE B, to the DA 125, e.g. to its DA platform 151. The DA platform 155 may stream the Voice message to the DA 125. The DA 125 may e.g. say “Last message from Bob is: “I am late for dinner” sent last night. What would you like to do now? This action relates to Action 509, 608 and 609 described below.

Personal Shared Secret Such as PIN is not Correct See FIG. 4

Action 411.

When established that the pin is NOT correct, the server node 150 sends to the DA 125, an instruction to provide an indication to the first user that the personal shared secret, in this example the PIN, is not correct and that access to the requested information is denied. This may e.g. be performed by instructing the DA 125 such as its platform 151 to provide a voice message in the DA 125 telling that “the PIN was not correct. Your voice message cannot be accessed.” The DA Platform 151 may then stream the voice message to the DA 125. The DA 125 may e.g. say “the PIN was not correct. Your voice message could not be accessed. What would you like to do?” This action relates to Action 510, 610 and 611 described below.

Method in the Server Node 150

Example embodiments of a method performed by the server node 150 for handling access control of a request to access information from the first user, will now be described with reference to a flowchart depicted in FIG. 5. The information is related to the first UE A1 of the first user. The information is requested to be provided as a voice message by the DA 125 used by the first user of the first UE A1. The DA 125 is shared by the first user of the first UE A1 and the second user of the second UE A2. Dashed boxes in FIG. represent optional actions. The method comprises the following actions, which actions may be taken in any suitable order.

Action 501

In an example scenario the first user defines access rules, e.g. relating to whether access control is needed for the content of a received voice messages or text messages or the call log that regards private and sensitive information that are to be delivered by the shared DA 125. The access rules defined by the first user may be registered in his/her voice profile at the server node, e.g. at is DB 155. The access rules may e.g. be a Pin also referred to as PIN code, or password or any other shared secret. Thus, in some embodiments, the server node 150 receives access rules defined by the first user. The access rules are associated with the voice profile identity of the first user of the first UE A1. The access rules are to be registered at the server node 150, e.g. to be stored in the DB 150, together with the associated voice profile identity of the first user.

Action 502

According to an example scenario the first user requests to access the information which e.g. may be to get her/his latest voice read by the DA 125, and has instructed the DA 125 in a voice message to do so. The server node 150 receives from the DA 125, the request to access the information, a voice profile identity identifying a voice profile associated with the first user of the first UE A1, and a group identity identifying a group of users of UEs sharing the DA 125. The group of users comprises at least the first user of the first UE A1 and the second user of the second UE A2. The group of users may e.g. be a family, a company, sports team etc.

Action 503

Based on the group identity, the server node 150 establishes that the first UE A1 uses the DA 125 that is shared.

Action 504

In some embodiments, the server node 150 consults access rules defined by the first user, which access rules are associated with the voice profile identity. This means that the server node may check the e.g. in the DA 125, for the registered voice profile and access rules relating to access control that applies to the first user.

Action 505

The server node 150 decides whether the first user of the first UE A1 is enforced to access control to get access to the requested information. The decision is based on the type of information requested, the voice profile identity, and that the DA 125 for providing the voice message is shared. There may e.g. be different access rules for different types of requested information, such as e.g. it may be different rules if trying to access voice messages than accessing a call log, and a user is getting bank pin codes via SMS and the user wants the messages to be protected, but he doesn't care about the voice messages, just for mention a few examples.

In some embodiments, the server node 150 has, in Action 504, consulted the access rules defined by the first user. In these embodiments the server node 150 performs the basing of the deciding on the voice profile identity, by basing the deciding on the consulted access rules defined by the first user. This may e.g. mean that the server node 150 uses the voice profile identity when consulting, e.g. looking up or checking, the access rules defined by the first user to find out if the access rules to see if the first user of the first UE A1 is enforced to access control to get access to the requested information.

The access rules may be enforced based on the voice profile id sent by an OTT cloud associated to the DA 125.

Action 506

In an example scenario, it may be decided that the first user of the first UE A1 is enforced to access control to get access to the requested information. In this example scenario, the server node 150 may instruct the DA 125 to request a personal shared secret from the first user. This is to authorise the first user. The personal shared secret may e.g. be a PIN also referred to as a PIN code.

Action 507

The server node 150 receives a personal shared secret from the first user and checks, in some embodiments, if the personal shared secret is correct. This may be checked and extracted from the first user's voice profile e.g. f saved in the DB 155.

Action 508

In some embodiments, when a correct personal shared secret is received from the first user via the DA 125, the server node 150 may obtain the requested information from an IMS node 130.

Action 509

In some of these embodiments, the server node 150 then sends the requested and obtained information to the DA 125 to be provided as a voice message to be heard by the authorised first user.

Action 510

In some embodiments, when a personal shared secret that is not correct, is received from the first user via the DA 125, the server node instructs the DA 125 to provide an indication to the first user, indicating that the personal shared secret is not correct and that access to the requested information is denied.

This may e.g. be performed by sending a message to the UE A1 or a voice message in the DA 125 to be heard by the first user, or sending nothing meaning that the access to the information is denied. A message saying that the access is denied may also be sent. In case the user wants it, a warning may also be sent, such as “Someone has tried to access to your private info”.

Method in the DA 125

Example embodiments of a method performed by the DA 125 for handling access control of a request to access information from the first user, will now be described with reference to a flowchart depicted in FIG. 6.

Dashed boxes in FIG. 6 represent optional actions. The method comprises the following actions, which actions may be taken in any suitable order.

Action 601

In some embodiments, the DA 125 receives access rules from the first user. The access rules are defined by the first user. The access rules are associated with the voice profile identity of the first user of the first UE A1.

Action 602

In some of these embodiments, the DA 125 sends the access rules together with the associated voice profile identity of the first user to the server node 150, to be registered at the server node 150.

Action 603

According to an example scenario the first user requests to access the information which e.g. may be to get her/his latest voice read by the DA 125, and therefore instructs the DA 125 in a voice message to do so. The DA 125 receives a voice message from the first user. The voice message comprises the request to access information. The information is related to the first UE A1 of the first user. I.e. the first user's UE A1. The information is requested to be provided as a voice message by the DA 125 used by the first user of the first UE A1. The DA 125 is shared by the first user of the first UE A1 and the second user of the second UE A2.

Action 604

The DA 125 sends to the server node 150: The request to access the information, a voice profile identity identifying a voice profile associated with the first user of the first UE A1, and a group identity identifying a group of users of UEs sharing the DA 125. The group of users comprises at least the first user of the first UE A1 and the second user of the second UE A2.

Action 605

When decided, e.g. by the server node 250, that the first user of the first UE A1 is enforced to access control to get access to the requested information based on the type of information requested, the sent voice profile identity and group identity, the DA 125 receives an instruction from the server node 150, to request a personal shared secret from the first user, for access control. As mentioned above the personal shared secret may e.g. be a PIN also referred to as a PIN code.

The decision that the first user of the first UE A1 is enforced to access control to get access to the requested information may further be based on the is based on the access rules defined by the first user

This may e.g. mean that the server node 150 uses the voice profile identity when consulting, e.g. looking up or checking, the access rules defined by the first user to find out if the access rules to see if the first user of the first UE A1 is enforced to access control to get access to the requested information.

Action 606

The DA 125 may then receive upon request, the requested personal shared secret from the first user authorising the first user.

Action 607

The DA 125 may then send the personal shared secret to the server node 150 for access control.

Action 608

In an example scenario wherein the personal shared secret sent to the server node 150 was correct and the first user thereby is authorised, the DA 125 may receive 608 the requested information from the server node 150.

Action 609

In the example scenario, the DA 125 then provides the requested information as a voice message to be heard by the authorised first user.

Action 610

In another example scenario wherein the personal shared secret sent to the server node 150 was not correct, the DA 125 receives an instruction from the server node 150. The instruction instructs the DA 125 to provide an indication to the first user that the personal shared secret is not correct and that access to the requested information is denied.

Action 611

In this other example scenario, the DA 125 indicates to the first user that the personal shared secret is not correct and that access to the requested information is denied. This may e.g. be performed by sending a message to the UE A1 or a voice message in the DA 125 to be heard by the first user, or sending nothing meaning that there the access to the information is denied.

An advantage of embodiments herein is that they may protect the privacy of the user by providing a flexible framework.

In the below Table 1 some examples of access rules are presented:

TABLE 1

| DA user Id | Voice profile id | Access rules/Policy | Service |
|---|---|---|---|
| Family_id | Mother_id (first user) | PIN | Voice & Text |
| | | | messages |
| Family_id | Mother_id (first user) | PIN | Call log |
| Family_id | Father_id (e.g second | Password | Voice & Text |
| | user) | | messages |
| Family_id | Child1_id (other user) | Just voice profile | Call log |
| | | (ie. no extra | |
| | | authentication | |
| | | needed) | |
| Family_id | Child1_id (other user) | Just voice profile | Text messages |
| | | (i.e. no extra | |
| | | authentication | |
| | | needed) | |
| Etc. | | | |

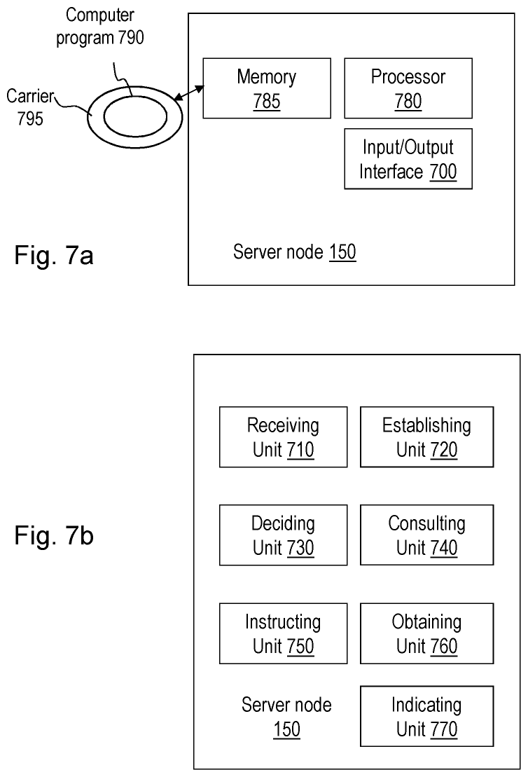

To perform the method actions above, the server node 150 is configured to handle access control of a request to access information from a first user, may comprise the arrangement depicted in FIG. 7a and FIG. 7b. The information is adapted to be related to the first UE A1 of the first user. The information is requested to be provided as a voice message by the DA 125 used by the first user of the first UE A1. The DA 125 is to be shared by the first user of the first UE A1 and the second user of a second UE A2.

The server node 150 may comprise an input and output interface 700 depicted in FIG. 7a, configured to communicate e.g. with the IMS node 130 and the DA 125. The input and output interface 700 may comprise a receiver (not shown) and a transmitter (not shown).

The server node 150 is further configured to, e.g. by means of a receiving unit 710 in the server node 150 depicted in FIG. 7b, receive from the DA 125, the request to access the information, a voice profile identity identifying a voice profile associated with the first user of the first UE A1, and a group identity identifying a group of users of UEs sharing the DA 125. the group of users is adapted to comprise at least the first user of the first UE A1 and the second user of the second UE A2.

The server node 150 is further configured to, e.g. by means of an establishing unit 720 in the server node 150 depicted in FIG. 7b, based on the group identity, establish that the first user of the first UE A1 uses the DA 125 that is shared.

The server node 150 is further configured to, e.g. by means of a deciding unit 730 in the server node 150 depicted in FIG. 7b, decide whether the first user of the first UE A1 is enforced to access control to get access to the requested information, based on the type of information requested, the voice profile identity and that the DA 125 for providing the voice message is shared.

The server node 150 is further configured to, e.g. by means of a consulting unit 740 in the server node 150 depicted in FIG. 7b, consult access rules defined by the first user, which access rules are associated with the voice profile identity.

The server node 150 is further configured to, e.g. by means of the deciding unit 730 in the server node 150 depicted in FIG. 7b, basing the deciding on the voice profile identity by basing the deciding on the consulted access rules defined by the first user.

The server node 150 is further configured to, e.g. by means of the receiving unit 710 in the server node 150 depicted in FIG. 7b, receive access rules defined by the first user. The access rules are adapted to be associated with the voice profile identity of the first user of the first UE A1. The access rules are adapted to be registered at the server node 150 together with the associated voice profile identity of the first user.

The server node 150 is further configured to, e.g. by means of a instructing unit 750 in the server node 150 depicted in FIG. 7b, when it is decided that the first user of the first UE A1 is enforced to access control to get access to the requested information, instruct the DA 125 to request a personal shared secret from the first user authorising the first user.

The server node 150 is further configured to, e.g. by means of a obtaining unit 760 in the server node 150 depicted in FIG. 7b, when receiving from the first user via the DA 125, a correct personal shared secret, obtain the requested information from an IMS node 130 and send it to the DA 125 to be provided as a voice message to be heard by the authorised first user.

The server node 150 is further configured to, e.g. by means of a indicating unit 770 in the server node 150 depicted in FIG. 7b, when receiving from the first user via the DA 125, a personal shared secret that is not correct, instruct the DA 125 to provide an indication to the first user, indicating that the personal shared secret is not correct and that access to the requested information is denied.

The embodiments herein may be implemented through a respective processor or one or more processors, such as a processor 780 of a processing circuitry in the server node 150 depicted in FIG. 7a, together with a respective computer program code for performing the functions and actions of the embodiments herein. The program code mentioned above may also be provided as a computer program product, for instance in the form of a data carrier carrying computer program code for performing the embodiments herein when being loaded into the network node 150. One such carrier may be in the form of a CD ROM disc. It is however feasible with other data carriers such as a memory stick. The computer program code may furthermore be provided as pure program code on a server and downloaded to the network node 150.

The server node 150 may further comprise a memory 785 depicted in FIG. 7a, comprising one or more memory units to store data on. The memory 785 comprises instructions executable by the processor 780. The memory 785 is arranged to be used to store e.g. enforcements, user policies, voice profiles, access rules, instructions, configurations and applications to perform the methods herein when being executed in the server node 150.

Those skilled in the art will also appreciate that the units in the radio server node 150 mentioned above may refer to a combination of analogue and digital circuits, and/or one or more processors configured with software and/or firmware, e.g. stored in the server node 150 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 790 comprises instructions, which when executed by the respective at least one processor 780, cause the at least one processor 780 of the server node 150 to perform the actions above.

In some embodiments, a carrier 795 comprises the computer program 790, wherein the carrier 795 is one of an electronic signal, an optical signal, an electromagnetic signal, a magnetic signal, an electric signal, a radio signal, a microwave signal, or a computer-readable storage medium.

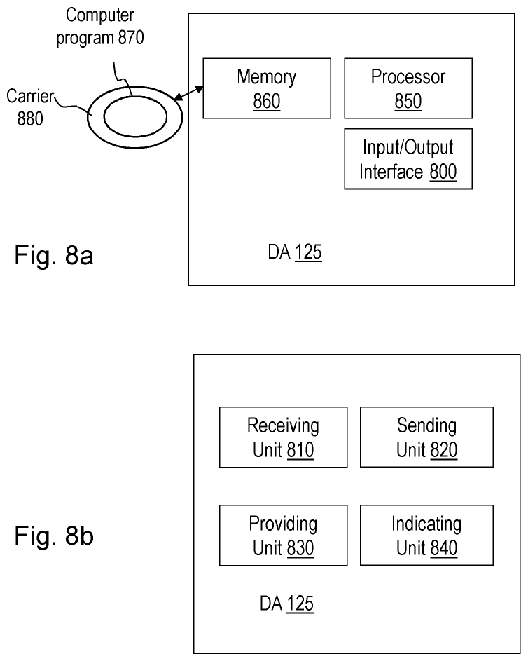

To perform the method actions above the DA 125 is configured to handle access control of a request to access information from the first user, which DA 125 may comprise the arrangement depicted in FIG. 8a and FIG. 8b.

The DA 125 may comprise an input and output interface 800 depicted in FIG. 8a, configured to communicate e.g. with the server node 150 and the user of the UE A1. The input and output interface 800 may comprise a receiver (not shown) and a transmitter (not shown).

The DA 125 is further configured to, e.g. by means of a receiving unit 810 in the DA 125 depicted in FIG. 8b, receive from the first user, a voice message comprising the request to access information. The information is adapted to be related to the first UE A1 of the first user. The information is requested to be provided as a voice message by the DA 125 used by the first user of the first UE A1. the DA 125 is adapted to be shared by the first user of the first UE A1 and the second user of the second UE A2.

The DA 125 is further configured to, e.g. by means of a sending unit 820 in the DA 125 depicted in FIG. 8b, send to a server node 150, the request to access the information, a voice profile identity identifying a voice profile associated with the first user of the first UE A1, and a group identity identifying a group of users of UEs sharing the DA 125. The group of users is adapted to comprise at least the first user of the first UE A1 and the second user of the second UE A2.

The DA 125 is further configured to, e.g. by means of the receiving unit 810 in the DA 125 depicted in FIG. 8b, when decided that the first user of the first UE A1 is enforced to access control to get access to the requested information based on the type of information requested, the sent voice profile identity and group identity, receive an instruction from the server node 150, to request a personal shared secret from the first user.

The DA 125 may further be configured to, e.g. by means of the receiving unit 810 in the DA 125 depicted in FIG. 8b, receive a personal shared secret from the first user authorising the first user upon request.

The DA 125 may further be configured to, e.g. by means of the sending unit 820 in the DA 125 depicted in FIG. 8b, send the personal shared secret to the server node 150 for access control.

The DA 125 may further be configured to, e.g. by means of the receiving unit 810 in the DA 125 depicted in FIG. 8b, receive from the first user, access rules defined by the first user, which access rules are associated with the voice profile identity of the first user of the first UE A1.

The DA 125 may further be configured to, e.g. by means of the sending unit 820 in the DA 125 depicted in FIG. 8b, send the access rules together with the associated voice profile identity of the first user to the server node 150, to be registered at the server node 150.

In some embodiments, wherein decided that the first user of the first UE A1 is enforced to access control to get access to the requested information based on the type of information requested, the sent voice profile identity and group identity, is adapted to be further based on the access rules defined by the first user.

The DA 125 may further be configured to, e.g. by means of the receiving unit 810 in the DA 125 depicted in FIG. 8b, when the personal shared secret sent to the server node 150 was correct, and the first user is authorised, receive the requested information from the server node 150.

The DA 125 may further be configured to, e.g. by means of a providing unit 830 in the DA 125 depicted in FIG. 8b, provide the requested information as a voice message to be heard by the authorised first user.

The DA 125 may further be configured to, e.g. by means of the receiving unit 810 in the DA 125 depicted in FIG. 8b, when the personal shared secret sent to the server node 150 was not correct, receive from the server node 150, an instruction to provide an indication to the first user that the personal shared secret is not correct and that access to the requested information is denied.

The DA 125 may further be configured to, e.g. by means of a indicating unit 840 in the DA 125 depicted in FIG. 8b, indicate to the first user that the personal shared secret is not correct and that access to the requested information is denied.

The embodiments herein may be implemented through a respective processor or one or more processors, such as a processor 850 of a processing circuitry in the DA 125 depicted in FIG. 8a, together with a respective computer program code for performing the functions and actions of the embodiments herein. The program code mentioned above may also be provided as a computer program product, for instance in the form of a data carrier carrying computer program code for performing the embodiments herein when being loaded into the DA 125. One such carrier may be in the form of a CD ROM disc. It is however feasible with other data carriers such as a memory stick. The computer program code may furthermore be provided as pure program code on a server and downloaded to the DA 125.

The DA 125 may further comprise a memory 860 comprising one or more memory units to store data on. The memory comprises instructions executable by the processor 850. The memory 860 is arranged to be used to store e.g. enforcements, user policies, voice profiles, access rules, instructions, configurations and applications to perform the methods herein when being executed in the DA 125.

Those skilled in the art will also appreciate that the units in the DA 125 mentioned above may refer to a combination of analogue and digital circuits, and/or one or more processors configured with software and/or firmware, e.g. stored in the DA 125 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 870 comprises instructions, which when executed by the respective at least one processor 850, cause the at least one processor 850 of the DA 125 to perform the actions above.

In some embodiments, a carrier 880 comprises the computer program 870, wherein the carrier 880 is one of an electronic signal, an optical signal, an electromagnetic signal, a magnetic signal, an electric signal, a radio signal, a microwave signal, or a computer-readable storage medium.

### FURTHER EXTENSIONS AND VARIATIONS

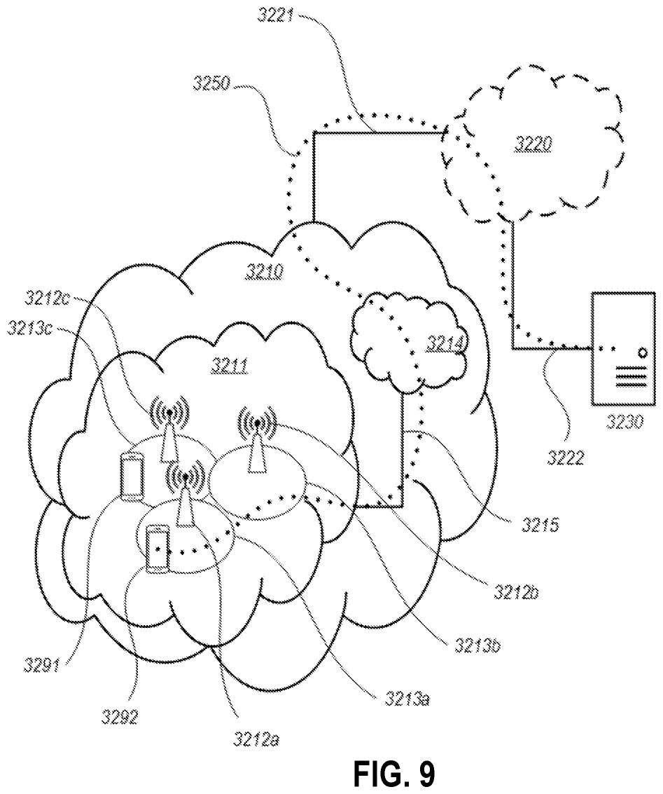

With reference to FIG. 9, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE A such as a Non-AP STA 3291 located in coverage area 3213c is configured to wirelessly connect to, or be paged by, the corresponding base station 3212c. A second UE 3292 e.g. the first or second radio node 110, 120 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

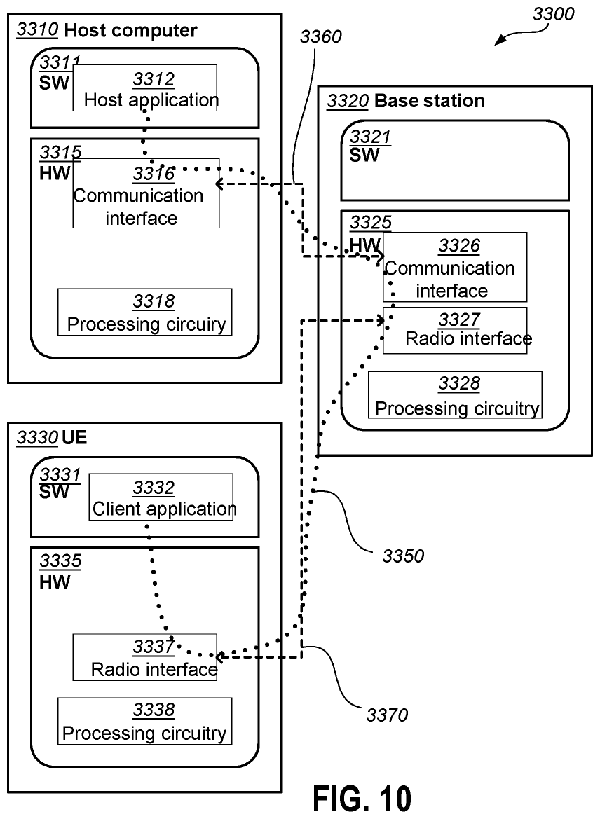

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

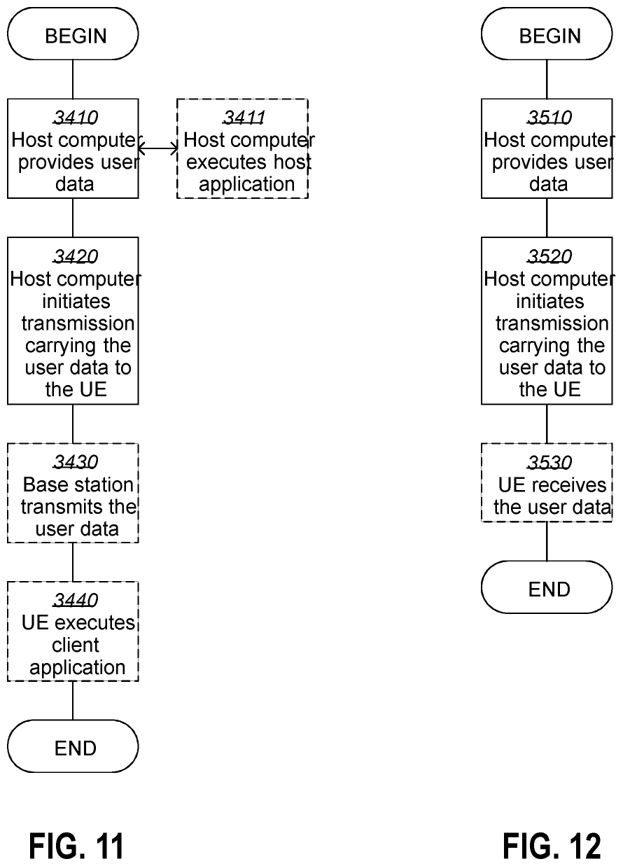

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 11 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 12 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

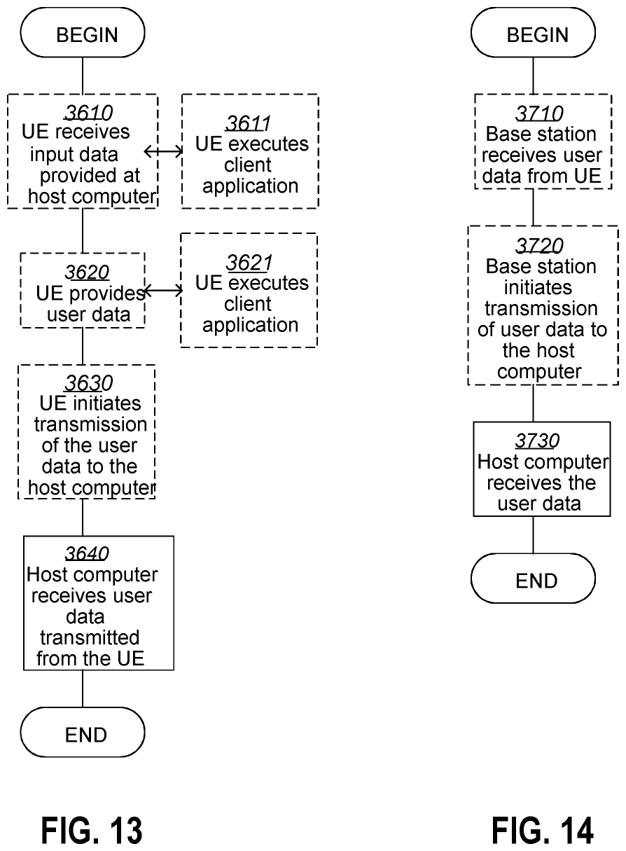

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 13 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a server node for handling access control of a request to access information from a first user, which information is related to a first User Equipment, UE, of the first user, and which information is requested to be provided as a voice message by a Digital Assistant, DA, used by the first user of the first UE, and which DA is shared by the first user of the first UE and a second user of a second UE, the method comprising:
receiving from the DA, the request to access the information, a voice profile identity identifying a voice profile associated with the first user of the first UE, and a group identity identifying a group of users of UEs sharing the DA, which group of users comprises at least the first user of the first UE and the second user of the second UE,
based on the group identity, establishing that the user of the first UE uses the DA that is shared,
deciding whether the first user of the first UE is enforced to access control to get access to the requested information based on the type of information requested, the voice profile identity and that the DA for providing the voice message is shared.

2. The method according to claim 1, further comprising:
consulting access rules defined by the first user, which access rules are associated with the voice profile identity, and
wherein, in basing the deciding on the voice profile identity comprises basing the deciding on the consulted access rules defined by the first user.

3. The method according to claim 1, further comprising:
receiving access rules defined by the first user, which access rules are associated with the voice profile identity of the first user of the first UE, which access rules are to be registered at the server node together with the associated voice profile identity of the first user.

4. The method according to claim 1, wherein it is decided that the first user of the first UE is enforced to access control to get access to the requested information, the method further comprising:
instructing the DA to request a personal shared secret from the first user authorising the first user.

5. The method according to claim 4, further comprising:
when receiving from the first user via the DA, a correct personal shared secret obtaining the requested information from an IMS node and sending it to the DA to be provided as a voice message to be heard by the authorised first user, and
when receiving from the first user via the DA, a personal shared secret that is not correct, instructing the DA to provide an indication to the first user, indicating that the personal shared secret is not correct and that access to the requested information is denied.

6. (canceled)

7. (canceled)

8. A method performed by a Digital Assistant, DA, for handling access control of a request to access information from a first user, the method comprising:
receiving from the first user a voice message comprising the request to access information, which information is related to a first User Equipment, UE, of the first user, and which information is requested to be provided as a voice message by a the DA used by the first user of the first UE, and which DA is shared by the first user of the first UE and a second user of a second UE,
sending to a server node, the request to access the information, a voice profile identity identifying a voice profile associated with the first user of the first UE, and a group identity identifying a group of users of UEs sharing the DA, which group of users comprises at least the first user of the first UE and the second user of a second UE,
when decided that the first user of the first UE is enforced to access control to get access to the requested information based on the type of information requested, the sent voice profile identity and group identity, receiving an instruction from the server node, to request a personal shared secret from the first user, for access control.

9. The method according to claim 8, further comprising:
receiving a personal shared secret from the first user authorising the first user upon request, and
sending the personal shared secret to the server node for access control.

10. The method according to claim 8, further comprising:
receiving from the first user, access rules defined by the first user, which access rules are associated with the voice profile identity of the first user of the first UE, and
sending the access rules together with the associated voice profile identity of the first user to the server node, to be registered at the server node.

11. The method according to claim 10, wherein when decided that the first user of the first UE is enforced to access control to get access to the requested information based on the type of information requested, the sent voice profile identity and group identity further is based on the access rules defined by the first user.

12. The method according to claim 10, further comprising:
when the personal shared secret sent to the server node was correct, and the first user is authorised, receiving the requested information from the server node, and
providing the requested information as a voice message to be heard by the authorised first user.

13. The method according to claim 10, further comprising:
when the personal shared secret sent to the server node was not correct, receiving from the server node, an instruction to provide an indication to the first user that the personal shared secret is not correct and that access to the requested information is denied, and
indicating to the first user that the personal shared secret is not correct and that access to the requested information is denied.

14. (canceled)

15. (canceled)

16. A server node configured to handle access control of a request to access information from a first user, which information is adapted to be related to a first User Equipment, UE, of the first user, and which information is requested to be provided as a voice message by a Digital Assistant, DA, used by the first user of the first UE, and which DA is to be shared by the first user of the first UE and a second user of a second UE, the server node further being configured to:
receive from the DA, the request to access the information, a voice profile identity identifying a voice profile associated with the first user of the first UE, and a group identity identifying a group of users of UEs sharing the DA, which group of users is adapted to comprise at least the first user of the first UE and the second user of the second UE,
based on the group identity, establish that the first user of the first UE uses the DA that is shared,
decide whether the first user of the first UE is enforced to access control to get access to the requested information, based on the type of information requested, the voice profile identity and that the DA for providing the voice message is shared.

17. The server node according to claim 16, further being configured to:
consult access rules defined by the first user, which access rules are associated with the voice profile identity, and
wherein the server node further is configured to basing the deciding on the voice profile identity is adapted to comprise basing the deciding on the consulted access rules defined by the first user.

18. The server node according to claim 16, further being configured to:
receive access rules defined by the first user, which access rules are adapted to be associated with the voice profile identity of the first user of the first UE, which access rules are adapted to be registered at the server node together with the associated voice profile identity of the first user.

19. The server node according to claim 16, further being configured to, when it is decided that the first user of the first UE is enforced to access control to get access to the requested information:
instruct the DA to request a personal shared secret from the first user authorising the first user.

20. The server node according to claim 19, further being configured to:
when receiving from the first user via the DA, a correct personal shared secret, obtain the requested information from an IMS node and send it to the DA to be provided as a voice message to be heard by the authorised first user, and
when receiving from the first user via the DA, a personal shared secret that is not correct, instruct the DA to provide an indication to the first user, indicating that the personal shared secret is not correct and that access to the requested information is denied.

21. A Digital Assistant, DA, configured to handle access control of a request to access information from a first user, the DA further being configured to:
receive from the first user, a voice message comprising the request to access information, which information is adapted to be related to a first User Equipment, UE, of the first user, and which information is requested to be provided as a voice message by the DA used by the first user of the first UE, and which DA is adapted to be shared by the first user of the first UE and a second user of a second UE,
send to a server node, the request to access the information, a voice profile identity identifying a voice profile associated with the first user of the first UE, and a group identity identifying a group of users of UEs sharing the DA, which group of users is adapted to comprise at least the first user of the first UE and the second user of the second UE,
when decided that the first user of the first UE is enforced to access control to get access to the requested information based on the type of information requested, the sent voice profile identity and group identity, receive an instruction from the server node, to request a personal shared secret from the first user.

22. The DA according to claim 21, further being configured to:
receive a personal shared secret from the first user authorising the first user upon request, and
send the personal shared secret to the server node for access control.

23. The DA according to claim 21, further being configured to:
receive from the first user, access rules defined by the first user, which access rules are associated with the voice profile identity of the first user of the first UE, and
send the access rules together with the associated voice profile identity of the first user to the server node, to be registered at the server node.

24. The DA according to claim 23, further being configured to: when decided that the first user of the first UE is enforced to access control to get access to the requested information based on the type of information requested, the sent voice profile identity and group identity is adapted to be further based on the access rules defined by the first user.

25. (canceled)

26. (canceled)
